(19) United States
(12) Patent Application Publication
(10) Pub. No.: US 2006/0104350 A1
(43) Pub. Date: May 18, 2006

(54) Multimedia encoder

(76) Inventor: Sam Liu, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/987,863

(22) Filed: Nov. 12, 2004

(51) Int. Cl. H04N 11/04; H04N 11/02; H04B 1/66; H04N 7/12

(52) U.S. Cl. 375/240.03; 375/240.16

(57) ABSTRACT

A video bit stream having a constant frame rate is generated from an input having a frame rate that is different than the constant frame rate. Zero-motion difference frames are added to the bit stream to achieve the constant frame rate. Bit rate control may include using a state transition model to determine a noise masking factor for the frame; and assigning a number of bits as a function of the noise masking factor.

### BACKGROUND

MPEG is a standard for compression, decompression, processing, and coded representation of moving pictures and audio. MPEG 1, 2 and 4 standards are currently being used to encode video into bit streams.

The MPEG standard promotes interoperability. An MPEG-compliant bit stream can be decoded and displayed by different platforms including, but not limited to, DVD/VCD, satellite TV, and personal computers running multimedia applications.

The MPEG standard leaves little latitude to optimize the decoding process. However, the MPEG standard leaves much greater latitude to optimize the encoding process. Consequently, different encoder designs can be used to generate compliant bit streams.

However, not all encoder designs produce the same quality bit stream. For example, bit allocation (or bit rate control) can play an important role in video quality. Encoders using different bit allocation schemes can produce bit streams of different quality. Poor bit allocation can result in bit streams of poor quality.

One challenge of designing a video encoder is producing high quality bit streams from different types of inputs, such as video, still images, and a mixture of the two. This challenge becomes more complicated if different video clips are captured from different devices and have different characteristics. The (output) bit stream likely has constant frame rate as mandated by the compression standard, but the input video sequences might not have the same frame rate.

Encoding of still images poses an additional problem. When a still image is displayed on a television, the image quality tends to “oscillate.” For example, the image as initially displayed appears fuzzy, but then becomes sharper, goes back to fuzzy, and so forth.

It is desirable to produce high-quality, compliant bit streams from different types of multimedia having different characteristics.

### SUMMARY

According to one aspect of the present invention, a video bit stream having a constant frame rate is generated from an input having a frame rate that is different than the constant frame rate. Zero-motion difference frames are added to the bit stream to achieve the constant frame rate.

According to another aspect of the present invention, bit rate control includes using a state transition model to determine a noise masking factor for a frame; and assigning a number of bits as a function of the noise masking factor.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of a multimedia system according to an embodiment of the present invention.

FIG. 2 is an illustration of a method of generating a bit stream having a constant frame rate from an input having a variable frame rate in accordance with an embodiment of the present invention.

FIG. 3 is an illustration of a method of performing quantization in accordance with an embodiment of the present invention.

FIG. 4 is an illustration of a simple state transition model according to an embodiment of the present invention.

FIG. 5 is an illustration of a more complex state transition model according to an embodiment of the present invention.

FIG. 6 is an illustration of an encoder according to an embodiment of the present invention.

FIG. 7 is an illustration of an encoder according to an embodiment of the present invention.

### DETAILED DESCRIPTION

As shown in the drawings for purposes of illustration, the present invention is embodied in the encoding of multimedia The present invention is especially useful for generating bit streams from multimedia including a combination of still images and video clips. The bit streams are high quality and they can be made compliant. Encoded still images do not “oscillate” during display.

Audio can be handled separately. According to the MPEG standard, for instance, audio is coded separately and interleaved with the video.

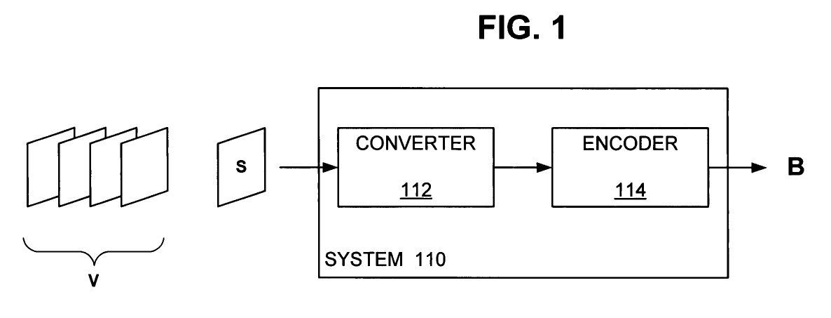

Reference is made to FIG. 1, which illustrates a multimedia system 110 for generating a compliant video bit stream (B) from an input. The input can include multimedia of different types. The different types include still images (S) and video clips (V). The still images can be interspersed with the video clips.

Different video clips can have different formats. Exemplary formats for the video clips include, without limitation, MPEG, DVI, and WMV. Different still images can have different formats. Exemplary formats for the still images include, without limitation, GIF, JPEG, TIFF, RAW, and bitmap.

The input may have a constant frame rate or a variable frame rate. For example, one video clip might have 30 frames per second, while another video clip has 10 frames per second. Other images might be still images.

The multimedia system 110 includes a converter 112 and an encoder 114. The converter 112 converts the input to a format expected by the encoder 114. For example, the converter 112 would ensure that still images and video are in the format expected by an MPEG-compliant encoder 114. This might include transcoding video and still images. The converter 112 would also ensure that the input is in a color space expected by the encoder 114. For example, the converter 112 might change color space of an image from RGB space to YCbCr or YUV color space. The converter 112 might also change the picture size.

The converter 112 supplies the converted input to the encoder 114. The converter 112 could also supply information about the input. The information might include input type (e.g., still image, video clip). If the input is a video clip, the information could also include frame rate of the video clip. If the input is a still image, the information could also include the duration for which the still image should be displayed. In the alternative, this information could be supplied to the encoder 114 via user input.

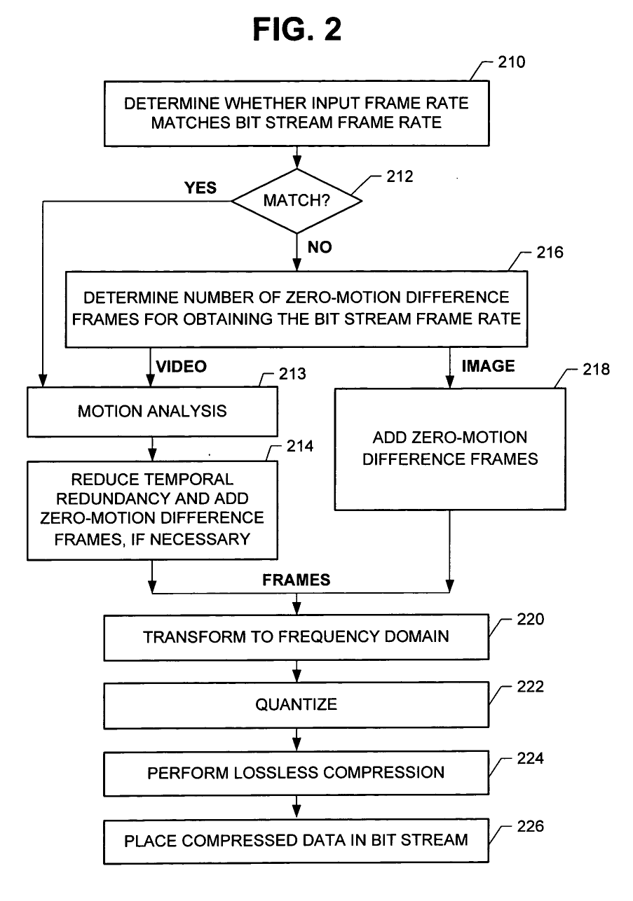

Additional reference is made to FIG. 2. The encoder 114 generates a compliant bit stream (B) having a constant frame rate, even if the input has a variable frame rate. The encoder 114 receives an input and determines whether the frame rate of the input matches the frame rate of the compliant bit stream (block 210). The frame rate of the input can be determined from the information supplied by the converter 112 or the frame rate can be determined from a user input. Instead, the encoder 114 could determine the input frame rate by examining headers of the input.

If the frame rates match (block 212), which means that the input is a video clip, the encoder 114 performs motion analysis (block 213) and uses the motion analysis to reduce temporal redundancy in the frames (block 214). The motion analysis may be performed according to convention. In addition to performing motion analysis, the encoder 114 may also analyze the content of each frame. The reason for analyzing scene content will be described later.

The temporal redundancy can be reduced by the use of independent frames and difference frames. An MPEG-compliant encoder, for example, would create groups of pictures. Each group of pictures (GOP) would start with an I-Frame (i.e., an independent frame), and would be followed by P-frames and B-frames. The P-frame is a difference frame that can show motion and pixel differences in a frame with respect to previous frames in its GOP. The B-frame is a difference frame that can show motion and pixel differences in a frame with respect to previous and future frames in its GOP.

If the frame rates do not match (block 212), the encoder determines the number of zero motion difference frames that are needed to obtain the frame rate of a compliant bit stream (block 216). A zero-motion difference frame is a frame having all forward or backward motion vectors with values of zero. If the input is a video clip having a frame rate of 10 frames-per-second (fps) and the bit stream frame rate is 30 fps, the encoder would determine that 20 zero-motion difference frames should be added for each second of video.

If the input is a video clip, the encoder 114 then reduces the temporal redundancy of the input (block 214). If necessary during this step, the encoder 114 can insert the zero-motion difference frames to achieve the constant frame rate. The encoder 114 can add the zero-motion difference frames before or after the temporal redundancy has been reduced. Consider an example in which an MPEG-compliant encoder received frames of a 10 fps video clip. For each frame received by the encoder 114 the encoder 114 could insert, on average, two P-frames indicating no motion and no pixel differences.

If the input is a still image, the encoder 114 does not need to perform motion analysis. Instead, the encoder 114 determines the duration over which the still image should be displayed (block 216) and adds the zero-motion difference frames to bit stream (block 218). If the still image should be displayed for three seconds and the frame rate of the bit stream is 30 fps, then the encoder 114 determines that 89 zero-motion difference frames should be added to obtain the frame rate of the bit stream.

The zero-motion difference frames would indicate motion-compensated pixel differences having zero values (these frames are hereinafter referred to as zero-motion difference frames indicating zero pixel differences), unless it is desired to improve the visual quality of the independent frame. Zero-motion difference frames indicating zero pixel differences can be compressed better than zero-motion difference frames indicating motion-compensated pixel values having non-zero pixel differences.

However, zero-motion difference frames indicating non-zero pixel differences can be used to improve the visual quality of the preceding I-frame. For example, the I-frame is assigned a sub-optimal number of bits prior to being placed in the bit stream. To improve the visual quality, the first several zero-motion difference frames following the I-frame would indicate non-zero pixel differences. The remaining zero-motion difference frames would indicate zero pixel differences.

If encoding is performed according to the MPEG standard, P-fames are the preferred difference frames. However, B-frames could be used instead of, or in addition to, the P-frames.

Consider an example in which the input consists of a still image that should be displayed for five seconds. An MPEG encoder may encode the still image as six identical GOPs, with each GOP containing twenty five frames (an I-frame followed by twenty four zero-motion P-frames). If the zero-motion P-frames indicate zero pixel difference, each I-frame will be displayed without any oscillation or other distracting motion.

The GOPs may be made identical so as to conform to a pre-decided GOP size. However, the bit stream could be non-compliant, in which case the GOPs need not be identical. Also, a GOP is not limited to twenty five frames. A GOP is allowed to contain arbitrary number of frames.

After the temporal redundancy has been exploited and a proper frame rate has been achieved, the encoder 114 transforms the frames from their spatial domain representation to a frequency domain representation (block 220). The frequency domain representation contains transform coefficients. An MPEG encoder, for example, converts macroblocks (e.g., 8×8 pixel blocks) of each frame to 8×8 blocks of DCT coefficients.

The encoder 114 performs lossy compression by quantizing the transform coefficients in the transform coefficient blocks (block 222). The encoder 114 then performs lossless compression (e.g., entropy coding) on the quantized blocks (block 224). The compressed data is placed in the bit steam (226).

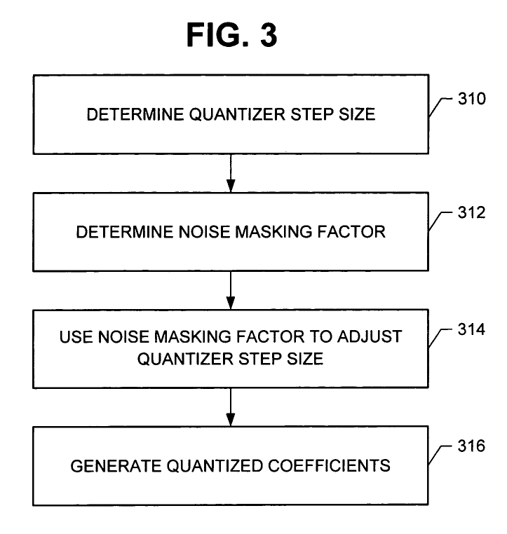

Reference is now made to FIG. 3, which illustrates a method of performing quantization on a frame of transform coefficients. Quantization involves dividing the transform coefficients by corresponding quantizer step sizes, and then rounding to the nearest integer. The quantizer step size controls the number of bits that are assigned to the quantized transform coefficients. (i.e., bit rate).

At block 310, a quantizer step size is determined. The quantizer step size may be determined in a conventional manner. For example, a quantizer table could be used to determine the quantizer step size.

The quantizer step size may also be determined according to decoding buffer constraints. One of the constraints is overflow/underflow of a decoding buffer. During encoding, the encoder keeps track of the exact number of bits that will be in the decoding buffer (assuming that the encoding standard specifies the decoding buffer behavior, as is the case with MPEG). If the decoding buffer capacity is approached, the quantizer step size is reduced so a greater number of bits are pulled from the buffer to avoid buffer overflow. If an underflow condition is approached, the quantizer step size is increased so fewer bits are pulled from the decoding buffer. The encoder adjusts the step size to avoid these overflow and underflow conditions. The encoder can also perform bit stuffing to avoid buffer overflow.

A noise masking factor is selected for each frame (block 312). The noise masking factor is determined according to scene content. The noise perceived by the human visual system can vary according to the content of the scene. In scenes with high texture and high motion, the human eye is less sensitive to noise. Therefore, fewer bits can be allocated to frame containing such content. Thus, the noise masking factor is assigned to achieve the highest visual quality at the target bit rate.

For example, a still image is assigned the highest noise masking factor (e.g., 1) so it can be displayed with the highest visual quality. Low motion video is assigned a lower noise masking factor (e.g., 0.7) than still images; high motion video is assigned a lower factor (e.g., 0.4) than low motion video, and scene changes are assigned the lowest factor (e.g., 0.3). Thus, more bits will be assigned to a still image than a scene change, given the same buffer constraints.

The noise masking factor is used to adjust the quantizer step size (block 314). The noise masking factor can be used to scale the quantization step, for example, by multiplying the quantization step by the noise masking factor.

The quantizer step sizes are used to generate the quantized coefficients (block 316). For example, a deadzone quantizer would use the step size as follows

$${q}_{i} = ⌊ \frac{\vert {c}_{i} \vert}{Δ} ⌋ sgn ( {c}_{i} )$$

where sgn is the sign of the transform coefficient c, Δ is the quantization step size., and q is the quantized transform coefficient.

Increasing the quantization step size can reduce image quality. If the quantizer step is increased for a still image (for example, to avoid buffer underflow), the number of bits assigned to the still image will be sub-optimal. Consequently, image quality of the still image will be reduced. To improve the quality of the still image, the encoder can add a few of the zero-motion difference frames indicating non-zero pixel differences.

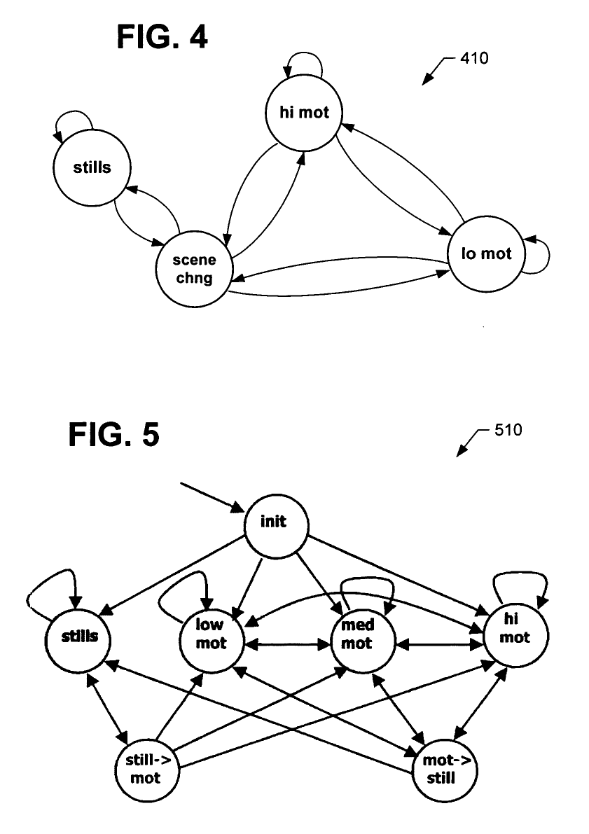

A transition state model can be used to determine the noise masking factors. Exemplary state transition models are illustrated in FIGS. 4 and 5.

Reference is now made to FIG. 4, which illustrates a simple state transition model 410 for determining a noise masking factor. The model 410 of FIG. 4 has four states: a first state for still images, a second state for scene changes, a third state for low-motion video, and a fourth state for high-motion video. Consider the example of an input consisting of a still image followed by first and second video clips. While the frames for the still image are being processed, the model 410 transitions to and stays in the first state (still image). While the first frame of the first video clip is being processed, the model 410 transitions to the second state (scene change). While subsequent frames of the first video clip are being processed, the model 410 transitions to either the third or fourth state (low-motion or high motion) and then transitions between the third and fourth states (assuming the first video clip contains high-motion and low-motion frames). While the first frame of the second video clip is being processed, the model 410 transitions back to the second state (scene change). The model then transitions to either the third and fourth state, and so forth.

FIG. 5 illustrates a more complex state transition model 510. The state transition model 510 of FIG. 5 includes a state for medium motion in addition to states for low and high motion. The noise masking factor for the medium motion state (e.g., 0.5) is between the noise masking factors for the low and high motion states.

The state transition model 510 of FIG. 5 includes two states corresponding to scene change instead of a single state: a still-to-motion state, and a motion-to-still state. The state transition model 510 of FIG. 5 also includes an initial state. The initial state can be used if the encoder does not know the state that a frame belongs to. For example, the first frame of a video clip to be encoded can be assigned an initial state, since no prior frame is available for motion analysis

The state transition model 510 of FIG. 5 has additional transitions. The medium motion state can transition to and from the high and medium states. All three motion states can transition to and from both scene change states. The still motion state can transition to and from both scene change states. The initial state can transition only to the still, low motion, medium motion, and high motion states.

A state transition model according to the present invention is not limited to any particular number of states or transitions. However, increasing the number of states and transitions can increase the complexity of the state transition model.

The transitions can be determined in a variety of ways. As a first example, a transition could be determined from information identifying the input type (video or still image). This information may be ascertained by the encoder (e.g., by examining headers) or supplied to the encoder (e.g., via manual input).

As a second example, a transition could be determined by identifying the amount of noise in the frames. For video clips, the encoder could determine the amount of motion from the motion vectors generated during motion analysis. The encoder could examine scene content such as the amount of texture). Changes in highly textured surfaces, for example, would not be readily perceptible to the human visual system. Therefore, a transition could be made to a state (e.g., high motion) corresponding to a lower noise masking factor.

Other models could have states corresponding to different texture amounts and different levels of noise. In general, the states can be defined by any relevant information that is related to the characteristics of the images and video.

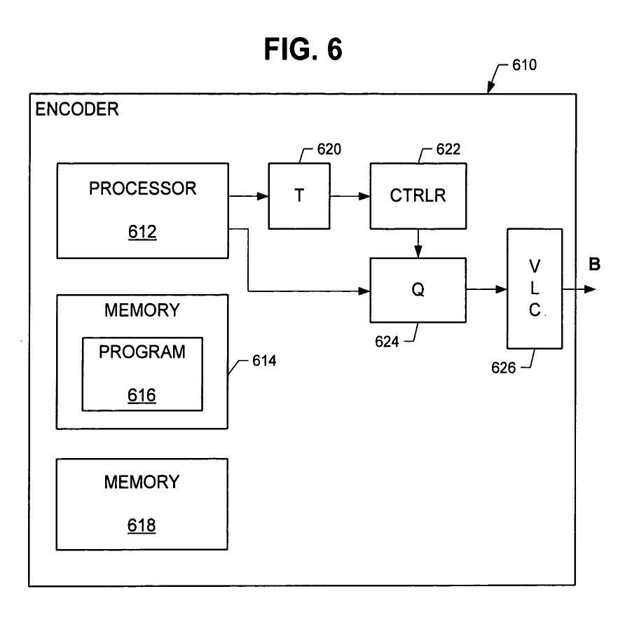

Reference is now made to FIG. 6, which illustrates an exemplary encoder 610. The encoder 610 includes a specialized processor 612 and memory 614. The memory 614 stores a program 616 for instructing the processor 612 to perform motion analysis, generate motion vectors, identify transitions, reduce spatial redundancy, adjust the frame rate by adding zero-motion difference frames, and transform the frames from the spatial domain to the frequency domain. The encoder 610 includes additional memory 618 for buffering input images, intermediate results, and blocks of transform coefficients.

The encoder 610 further includes a state machine 620, which implements a state transition model. The processor 612 supplies the different states to the state machine 620, and the state machine 620 supplies noise masking factors to a bit rate controller 622. The bit rate controller 622 uses the noise masking factors to adjust the quantizer step sizes, and a quantizer 624 uses the adjusted quantizer step sizes to quantize the transform coefficient blocks. Lossless compression is then performed by a variable length coder 626. A bit stream having a constant frame rate is provided on an output of the variable length coder (VLC) 626.

The encoder may be implemented as an ASIC. The bit rate controller 622, the quantizer 624 and the variable length coder 626 may be implemented as individual circuits.

The ASIC may be part of a machine that does encoding. For example, the ASIC may be on-board a camcorder or a DVD writer. The ASIC would allow real-time encoding. The ASIC may be part of a DVD player or any device that needs encoding of video and images.

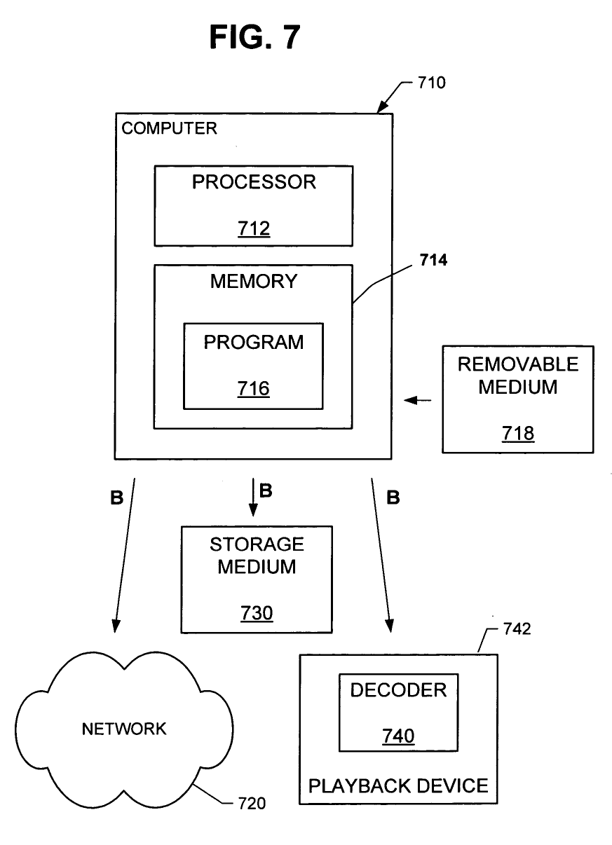

Reference is now made to FIG. 7, which illustrates a software implementation of the encoding. A computer 710 includes a general-purpose processor 712 and memory 714. The memory 714 stores a program 716 that, when run, instructs the processor 712 to perform motion analysis, generate motion vectors, identify transitions, reduce spatial redundancy, adjust the frame rate by adding zero-motion difference frames, and generate transform coefficients from the frames. The program 716 also instructs the processor 712 to determine noise masking factors and quantizer step sizes, adjust the quantizer step sizes with the noise masking factors, use the adjusted noise masking factors to quantize the transform coefficients, perform lossless compression of the quantized coefficients, and place the compressed data in a bit stream.

The program 716 may be a standalone program or part of a larger program. For example. the program 716 may be part of a video editing program. The program 716 may be distributed via electronic transmission, via removable media (e.g., a CD) 718, etc.

The computer 710 can transmit the bit stream (B) to another machine (e.g., via a network 720), or store the bit stream (B) on a storage medium 730 (e.g., hard driver, optical disk). If the bit stream (B) is compliant, it can be decoded by a compliant decoder 740 of a playback device 742.

Although several specific embodiments of the present invention have been described and illustrated, the present invention is not limited to the specific forms or arrangements of parts so described and illustrated. Instead, the present invention is construed according to the following claims.

1. A method of generating a video bit stream having a constant frame rate, the video bit stream generated from an input having a frame rate that is different than the constant frame rate, the method comprising adding zero-motion difference frames to the bit stream to achieve the constant frame rate.

2. The method of claim 1, wherein the zero-motion difference frames are frames indicating zero motion and zero pixel difference.

3. The method of claim 1, wherein the input is a still image; wherein an independent frame of the still image is added to the bit stream; and wherein a group of the difference frames follow the independent frame, the difference frames in the group also indicting zero pixel difference.

4. The method of claim 3, further comprising adding a second group of the difference frames to the bit stream, between the independent frame and the first group, the difference frames in the second group indicating zero motion and non-zero pixel differences.

5. The method of claim 4, wherein the non-zero pixel differences result from sub-optimal bit allocation to the independent frame.

6. The method of claim 1, further comprising using a state transition model to adjust a quantizer step size for each frame.

7. The method of claim 6, wherein the state transition model is used to generate a noise masking factor, and the noise masking factor is used to adjust the quantizer step size.

8. The method of claim 7, wherein each state of the model corresponds to a noise masking factor; and transitions between the states are determined by at least one of frame type, relative amount of motion with a previous frame, and a relative amount of noise in the frame.

9. The method of claim 8, wherein the noise masking factor is directly proportional to the amount of relative motion.

10. The method of claim 8, further comprising generating motion vectors for video input; wherein determining the relative motion includes examining the motion vectors.

11. The method of claim 6, wherein the quantizer step size is also a function of decoding buffer constraints; and wherein the noise masking factor is used to compensate for sub-optimal bit allocations arising from the decoding buffer constraints.

12. A method of generating a video bit stream from a still image, the method comprising placing an independent frame of the image in the bit stream, followed by a group of zero-motion difference frames.

13. A method of controlling bit rate of a video frame, the method comprising:
using a state transition model to determine a noise masking factor for the frame; and
assigning a number of bits as a function of the noise masking factor.

14. The method of claim 13, further comprising generating a baseline quantizer step size; and wherein assigning the number of bits includes scaling the quantizer step size with the noise masking factor.

15. The method of claim 13, wherein each state of the model relates an relative amount of noise to a noise masking factor; and wherein transitions between the states are determined by at least one of frame type, relative amount of motion with a previous frame, and a relative amount of noise in the frame.

16. The method of claim 13, wherein the noise masking factor is directly proportional to the amount of motion relative to a previous frame.

17. Apparatus for generating a video bit stream having a constant frame rate from an input having a frame rate that is different than the constant frame rate, the apparatus comprising:
means for determining a number of zero-motion difference frames to be added to the bit stream in order to achieve the constant frame rate; and
means for adding the frames to the bit stream.

18. Apparatus comprising:
means for using a state transition model to determine a noise masking factor based on relative noise in a video frame; and
means for determining a quantizer step size for the frame as a function of the noise masking factor.

19. A multimedia encoder comprising a processor for generating a video bit stream having a constant frame rate from an input having a frame rate that is different than the constant frame rate, the processor adding zero-motion difference frames to the bit stream to achieve the constant frame rate.

20. The encoder of claim 19, wherein the zero-motion difference frames include frames indicating zero motion and zero pixel difference.

21. The encoder of claim 19, wherein if the input is a still image, an independent frame of the still image is added to the bit stream and a group of the zero-motion difference frames follow the independent frame, the zero-motion difference frames in the group indicting zero pixel differences.

22. The encoder of claim 21, wherein a second group of the zero-motion difference frames is added to the bit stream, between the independent frame and the first group, the difference frames in the second group indicating zero motion and non-zero pixel differences.

23. The encoder of claim 19, wherein a state transition model is used to adjust a quantizer step size for each frame.

24. The encoder of claim 23, wherein the state transition model is used to generate a noise masking factor, and the noise masking factor is used to adjust the quantizer step size.

25. The encoder of claim 23, wherein the quantizer step size is also a function of decoding buffer constraints; and wherein the noise masking factor is used to compensate for sub-optimal bit allocations arising from the decoding buffer constraints.

26. A multimedia encoder comprising a processor for determining a noise masking factor based on scene content in a frame, and quantizing the present frame at a quantizer step that is a function of the noise masking factor.

27. An article for a processor, the article comprising memory encoded with data for instructing the processor to generate a video bit stream having a constant frame rate from an input having a frame rate that is different than the constant frame rate, the processor being instructed to add zero-motion difference frames to the bit stream to achieve the constant frame rate.

28. An article for a processor, the article comprising memory encoded with data for instructing the processor determine a noise masking factor based on noise between a current video frame and a previous video frame, and quantize the current frame at a quantizer step that is a function of the noise masking factor.
